(19) United States
(12) Patent Application Publication
(10) Pub. No.: US 2026/0319163 A1
(43) Pub. Date: Oct. 15, 2026

(54) Modular Edge-Lit Lighting System for Light-Transmissive Stone Surfaces and a Method of Fabrication and Installation Thereof

(71) Applicant: Pranav Kumar, Gurugram (IN)

(72) Inventor: Pranav Kumar, Gurugram (IN)

(21) Appl. No.: 19/647,004

(22) Filed: Apr. 14, 2026

(30) Foreign Application Priority Data
Apr. 15, 2025 (IN) 202511036525

(51) Int. Cl. F21V 8/00; F21V 33/00; F21W 121/00

(52) U.S. Cl. CPC G02B 6/009; F21V 33/006; F21W 2121/00

(57) ABSTRACT

A method of completing an illuminated stone panel is disclosed. A stone-panel laminate is provided and includes a translucent stone layer, a light-guiding layer, a backing structure, and one or more optical interface layers between adjacent layers. The laminate, as a whole, undergoes at least one edge-related fabrication operation using standard stone-fabrication tools while both an elongate light source and an adhesive interface arrangement are absent from an exposed edge region of the light-guiding layer. The adhesive interface arrangement is then selected, sized, or trimmed to correspond to fabricated edge dimensions, the elongate light source is attached to the adhesive interface arrangement, and the elongate light source is positioned in optical coupling with the exposed edge region. The laminate passes through a stone-fabrication workflow before later lighting completion, and the translucent stone layer does not define the receiving recess, groove, cavity, or channel for the elongate light source.

### FIELD OF THE INVENTION

The present invention relates to lighting integration systems for translucent stone materials. More particularly, the invention relates to modular edge-lit lighting systems configured for use with rigid translucent stone slabs, thin translucent stone veneers, resin-bonded translucent stone slabs, and composite translucent stone panels, and natural translucent stone slabs, including systems that allow post-fabrication installation, servicing, or replacement of lighting components. The invention is applicable to architectural surfaces such as wall panels, backsplashes, countertops, tabletops, furniture elements, and other installations requiring illumination of translucent stone while maintaining structural integrity and serviceability.

### BACKGROUND OF THE INVENTION

Translucent natural stone and stone-based materials are increasingly used in architectural and decorative applications due to their visual properties when illuminated. Known lighting solutions for such materials typically rely on backlighting arrangements in which light sources are permanently enclosed behind a stone panel or slab. Such approaches often require factory-level customization, rigid panel geometries, and permanent integration of lighting components prior to installation.

Conventional backlit stone systems commonly suffer from limitations. Once installed, lighting components are generally inaccessible, making maintenance or replacement difficult or impossible without removing or damaging the stone surface. Existing systems are also poorly suited to on-site fabrication or final-stage sizing because lighting components are often fixed before cutting, templating, or edge-processing operations are completed. In addition, permanent civil modifications associated with traditional underlighting or backlighting arrangements, including cavities and recessed walls, may leave substrates, cabinets, and other support structures permanently damaged when the lighting apparatus is later removed. These limitations create inefficiencies for fabricators and installers, particularly where stone panels must be trimmed, modified, or adapted to site-specific conditions.

In many conventional commercial workflows for illuminated stone installations, fabrication of the translucent stone component and provision of lighting components are performed by different entities. A stone fabricator commonly performs templating, cutting, edge profiling, mitering, polishing, sink or fixture cutouts, and installation preparation on the stone component, while a lighting or electrical supplier separately provides light sources, drivers, housings, or other lighting elements later coordinated through an installer or contractor. Conventional workflows therefore commonly do not provide a fabrication-ready stone-panel laminate that can be handled and edge-fabricated as a whole using standard stone-fabrication tools before later completion with edge-mounted lighting components.

Translucent stone veneers, resin-bonded translucent stone slabs, composite translucent stone panels, and reinforced natural translucent stone slabs may be known individually.

However, existing solutions do not provide a unified lighting integration system that accommodates different translucent stone constructions while preserving modularity, serviceability, and fabrication flexibility. There therefore exists a need for a lighting system that can be adapted to various translucent stone formats, supports post-fabrication or on-site installation of lighting components, and enables continued access to lighting elements after the stone surface has been installed.

This industry separation creates practical barriers to integrated fabrication. Where lighting elements are pre-installed, standard stone-fabrication operations may be impeded, delayed, or transferred away from the stone fabricator. Where the stone is fabricated first as a stand-alone article and lighting is later coordinated separately, the resulting workflow increases dependency on multiple trades and limits the availability of a unified intermediate article that is both stone-fabrication-compatible and later completable into an illuminated panel. The disclosed architecture addresses this divide by enabling a stone-panel laminate to be fabricated as a whole and later completed by addition of edge-mounted lighting components.

Unlike conventional backlit stone systems that permanently embed LEDs behind the stone surface, the present invention provides a modular edge-lit architecture that permits installation, servicing, and replacement of lighting components after fabrication and installation of the stone layer. Conventional systems typically require factory-level customization and result in inaccessible lighting once installed, whereas the disclosed system introduces fabrication-compatible interface arrangements and access structures that allow post-installation maintenance without removal or damage to the stone. This distinction supports flexible workflows for fabricators and installers, accommodates multiple stone constructions, and preserves long-term serviceability in architectural environments.

### SUMMARY OF THE INVENTION

The invention provides a modular edge-lit lighting system for illuminating translucent stone materials, including rigid translucent stone slabs, thin translucent stone veneers, resin-bonded translucent stone slabs, composite translucent stone panels, and natural translucent stone slabs. The system includes a light-guiding layer positioned adjacent to a translucent stone layer, a backing structure arranged on an opposite side of the light-guiding layer, the light-guiding layer and backing structure together defining a panel stack, one or more optical interface layers positioned between adjacent layers of a stone-panel laminate and providing bonding and optical coupling between adjacent layers, and, when present, at least one edge-mounted light source optically coupled to the light-guiding layer to distribute light beneath the stone.

The lighting system is arranged as a modular assembly in which the light-guiding layer and the backing structure define a fabrication-compatible panel stack. In preferred commercial embodiments, the translucent stone layer, the panel stack, and one or more optical interface layers together form, as a fabrication-ready intermediate article, a stone-panel laminate before installation of an elongate light source. In preferred completion embodiments, an adhesive interface arrangement is positioned along an exposed edge region of the light-guiding layer and/or an adjacent portion of the panel stack only after at least one edge-related fabrication operation has been performed on the stone-panel laminate while the exposed edge region remains free of both the adhesive interface arrangement and the elongate light source. The adhesive interface arrangement is thereafter selected, sized, or trimmed according to fabricated edge dimensions and carries and positions the elongate light source in optical coupling with the exposed edge region. Alternative interface structures remain disclosed for other embodiments.

In certain embodiments, the lighting system may be provided as a kit or modular package comprising a standard-sized panel stack and one or more associated lighting components for downstream integration. In preferred commercial embodiments, the invention is supplied as a stone-panel laminate comprising the translucent stone layer, the panel stack, and one or more optical interface layers positioned between adjacent layers of the laminate and providing bonding and optical coupling between adjacent layers, without requiring the presence of the elongate light source, interface arrangement, access arrangement, cover element, or other edge-mounted lighting components at the time of supply. The disclosed architecture may remain as the stone-panel laminate or may receive the elongate light source and associated edge-mounted components after job-specific fabrication, installation, or final edge processing, thereby defining an illuminated stone panel. In other embodiments, the invention may be supplied as a modular lighting panel or kit comprising the panel stack and, where applicable, one or more associated interface components for downstream integration with a selected translucent or semi-translucent stone layer by a fabricator, installer, builder, distributor, designer, or other downstream user. In such embodiments, the panel stack, stone-panel laminate, and elongate light source may be shipped, supplied, or handled separately, and the elongate light source and associated edge-mounted components may be installed only after final fabrication, trimming, templating, shaping, routing, edge processing, or other job-specific processing of the translucent stone structure, stone-panel laminate, and/or illuminated stone assembly, thereby preserving fabrication flexibility while maintaining edge-based serviceability. In preferred embodiments, the disclosed architecture is first embodied as a fabrication-ready intermediate article in the form of a stone-panel laminate comprising the translucent stone layer, the light-guiding layer, the backing structure, and one or more optical interface layers, with the elongate light source omitted during at least one fabrication operation and added later at an exposed edge region of the light-guiding layer to define the illuminated stone panel.

In certain preferred commercial workflows, the stone-panel laminate constitutes a fabrication-ready intermediate article that is handled and edge-fabricated as a whole by a stone fabricator using standard stone-fabrication equipment and operations applicable to stone panels, including one or more of trimming, edge profiling, mitering, polishing, shaping, routing, templating, and cutout formation, before later completion with an adhesive interface arrangement and an elongate light source at an exposed edge region of the light-guiding layer. This workflow preserves access to the exposed edge region during fabrication, reduces reliance on pre-installed edge-lighting hardware during stone fabrication, and reduces coordination burdens associated with split stone-fabrication and lighting-supply workflows.

In certain embodiments, final lighting completion is performed after final sizing of the stone-panel laminate or, where applicable, after final sizing of the translucent stone layer before incorporation into the stone-panel laminate, including during on-site installation. The system is adaptable to different stone constructions and thicknesses while maintaining illumination, structural support, and long-term serviceability. Optional spacing regions, clearance gaps, localized edge accommodations, or surrounding-installation recesses may be provided where desired; however, in preferred embodiments, the elongate light source is positioned in optical coupling with the exposed edge region of the light-guiding layer, and the translucent stone layer does not define the operative recess, groove, cavity, or channel that receives and retains the elongate light source.

The terms “light-guiding layer” and “light-guide plate” are used interchangeably herein. As used herein, the term “panel stack” refers to the fabrication-compatible layered subassembly comprising at least the light-guiding layer (120) and the backing structure (130), and optionally one or more optical interface layers (180), exclusive of the translucent stone layer (110) unless expressly stated otherwise. The term “stone-panel laminate” refers to an assembly in which the translucent stone layer (110) is combined with the panel stack and one or more optical interface layers (180) positioned between adjacent layers of the laminate to provide bonding and optical coupling between adjacent layers, without requiring the presence of the elongate light source (150), interface arrangement (160), access arrangement (170), cover element (190), or other edge-mounted lighting components; unless expressly stated otherwise, the same assembly may remain as the stone-panel laminate after such edge-mounted lighting components are later added. The term “lighting panel” refers to a modular lighting subassembly comprising the panel stack and, in certain embodiments, one or more associated interface arrangements (160), access arrangements (170), cover elements (190), or associated lighting components, whether supplied in assembled or partially assembled form, and generally exclusive of the translucent stone layer (110) unless expressly stated otherwise. The term “illuminated stone assembly” refers to an assembly in which the translucent stone layer (110) is combined with the lighting panel or stone-panel laminate and, where applicable, the elongate light source (150) and associated edge-mounted components. Unless expressly indicated otherwise, references to a “lighting assembly” or “panel assembly” are to be understood in context as referring to the panel stack, the lighting panel, the stone-panel laminate, or the illuminated stone assembly, as applicable. In certain preferred embodiments, the disclosed architecture is embodied as an illuminated stone panel or as a stone-panel laminate that later receives an elongate light source positioned in optical coupling with an exposed edge region of the light-guiding layer and positioned and retained by the interface arrangement without requiring the translucent stone layer to define the operative recess, groove, cavity, or channel that receives and retains the elongate light source. In this context, an illuminated stone panel may constitute an illuminated stone assembly, and an illuminated stone assembly may be embodied as an illuminated stone panel, depending on form factor and installation state.

### BRIEF DESCRIPTION OF THE DRAWINGS

FIG. 1 is an exploded perspective view of a modular edge-lit lighting system showing a translucent stone layer (110), a light-guiding layer (120), a backing structure (130), an elongate light source (150), and an interface arrangement (160) positioned along an edge region of the light-guiding layer.

FIG. 2 is a cross-sectional view of the modular edge-lit lighting system showing optical coupling between the elongate light source (150) and an edge region (140) of the light-guiding layer (120), together with positioning of the interface arrangement (160), including an adhesive interface arrangement in certain embodiments.

FIG. 3 is a schematic sequential view illustrating preparation of the translucent stone layer (110) and the panel stack comprising the light-guiding layer (120) and the backing structure (130) for lamination into a stone-panel laminate, fabrication or sizing operations (300) performed on the stone-panel laminate as a whole to define an exposed edge region (140), and later installation of the interface arrangement (160) and the elongate light source (150) at the exposed edge region (140).

FIG. 4 is a schematic exploded perspective view of an embodiment configured for thin translucent stone veneer panels.

FIG. 5 is a schematic exploded perspective view of an embodiment configured for translucent stone slabs and composite translucent stone panels, optionally including an internal core or reinforcement structure (200).

FIG. 6 is a cross-sectional view of an embodiment configured for translucent stone slabs (110), illustrating a panel configuration including an optical interface layer (180), an interface arrangement (160) associated with edge-mounted light source retention, a reinforcement structure (200), and an architectural environment (400), and further illustrating spacing or clearance adjacent to the interface arrangement for heat dissipation and, in certain embodiments, service access.

FIG. 7 provides detail views of representative optional interface arrangements (160) and access arrangements (170), including edge-mounted retention structures, corner connection elements, and optional inward-set edge variation configurations illustrating representative implementations of such interface and access features in different edge geometries.

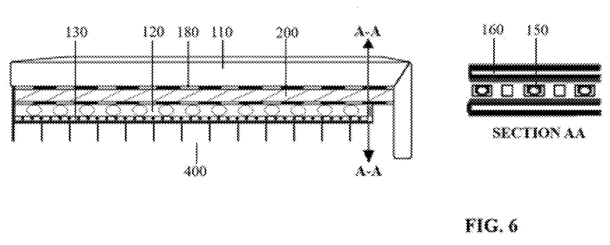

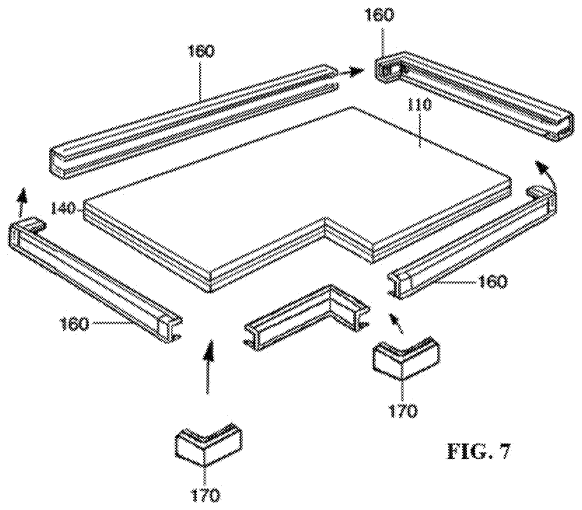

FIGS. 6-7 illustrate additional embodiments and implementation configurations of the lighting integration system, including thermal and service-access spacing arrangements, sectional refinements, optional inward-set edge variations, and edge-finishing elements, without departing from the modular lighting system architecture defined herein.

### DETAILED DESCRIPTION OF THE INVENTION

### 1. General System Architecture

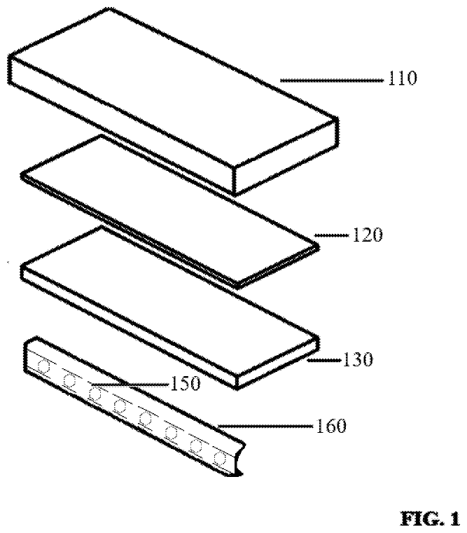

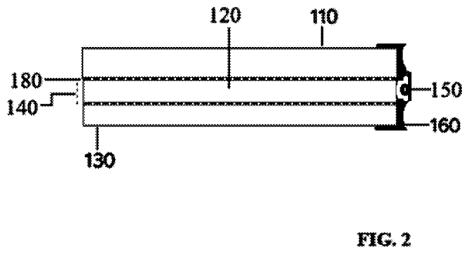

Referring to FIGS. 1 and 2, the modular edge-lit lighting system comprises a translucent stone layer (110), a light-guiding layer (120) positioned adjacent to the translucent stone layer, and a backing structure (130) arranged on an opposite side of the light-guiding layer. In preferred commercial embodiments, one or more optical interface layers (180) are positioned between adjacent layers of the stone-panel laminate and provide bonding and optical coupling between adjacent layers of the laminate. In completion embodiments, an elongate light source (150) is subsequently positioned along an exposed edge region (140) of the light-guiding layer after fabrication of the stone-panel laminate and is maintained in operative optical alignment by an interface arrangement (160), including an adhesive interface arrangement in certain embodiments. In certain embodiments, an access arrangement (170) permits installation, servicing, replacement, or adjustment of the elongate light source after integration of the translucent stone layer. The one or more optical interface layers (180) may comprise a protective film, a separator layer, an adhesive layer, an optical bonding layer, or a combination thereof and, in preferred commercial embodiments, provide both bonding and optical coupling between adjacent laminate layers.

In certain embodiments, the optical interface layer (180) may function as a separator layer, a protective layer, an adhesive interface, an optical bonding interface, or a combination thereof between adjacent layers of the stone-panel laminate. In some embodiments, the optical interface layer (180) may comprise a single layer or a plurality of interface sublayers, including a transparent or translucent separator sheet and a separate adhesive or optical bonding layer arranged together to facilitate bonding, protection, optical coupling, load distribution, and structural integrity of the assembled stone-panel laminate. The optical interface layer may be applied using standard panel lamination or bonding processes, including vacuum-assisted lamination, roller-based lamination, pressing, de-bubbling, or other suitable consolidation techniques to promote optical uniformity and reduce trapped air or bubble formation. The selection, thickness, sequence, and placement of such interface sublayers may be varied depending on the stone construction, panel configuration, and installation requirements without limiting the modular and serviceable architecture of the system. For clarity, the one or more optical interface layers (180) may comprise a single interface layer or a plurality of interface sublayers, including one or more separator layers, protective layers, adhesive layers, optical bonding layers, or combinations thereof.

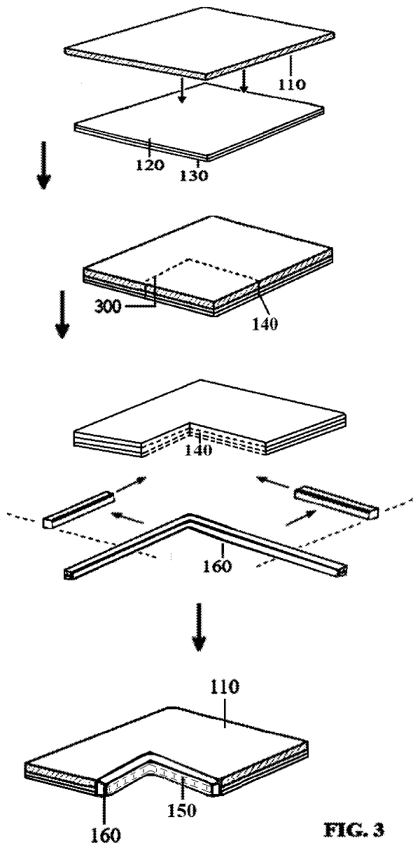

As further illustrated in FIGS. 3-7, the modular edge-lit lighting system may be fabricated, integrated, installed, and finished in a variety of configurations while retaining the structural arrangement described with reference to FIGS. 1 and 2, with FIGS. 6-7 further illustrating optional interface and access implementations.

In certain embodiments, the translucent stone layer (110) may further comprise or be associated with an internal core or reinforcement structure (200), including but not limited to a honeycomb panel, composite substrate, or structural reinforcement layer configured to improve mechanical stability, reduce weight, or enhance handling characteristics without affecting optical coupling.

In certain embodiments, an optional cover element (190) may be provided over the interface arrangement (160), the cover element being configured to conceal the light source and interface components while maintaining accessibility for service or replacement.

In certain embodiments, fabrication operations associated with the lighting integration system are represented schematically in FIG. 3 as fabrication or sizing operations (300). In preferred completion embodiments, the translucent stone layer (110) is prepared for lamination with the panel stack comprising the light-guiding layer (120) and the backing structure (130), and the resulting stone-panel laminate is fabricated as a whole by one or more cutting, trimming, shaping, templating, routing, mitering, or edge-finishing operations before installation of the interface arrangement (160) and the elongate light source (150), such that the fabrication operations define or finalize the exposed edge region (140) and the dimensions according to which the interface arrangement (160) is later selected, sized, or trimmed, with the elongate light source (150) thereafter being positioned by the interface arrangement (160) in optical coupling with the exposed edge region (140).

The lighting integration system may further be installed within or associated with an architectural environment (400), including but not limited to countertops, wall panels, cabinetry, furniture structures, or other architectural assemblies, wherein the system is configured to operate without requiring permanent structural modification to the surrounding environment.

The modular edge-lit lighting system described herein is configured for use with a translucent stone layer, including rigid translucent stone slabs, thin translucent stone veneers, resin-bonded translucent stone slabs, and composite translucent stone panels, and natural as well as engineered translucent and semi-translucent stone slabs. The lighting system is defined independently of a specific stone construction and is adaptable for integration with different stone formats, thicknesses, and reinforcement structures.

In a general configuration, the system comprises a light-guiding layer positioned adjacent to the translucent stone layer. The light-guiding layer is configured to receive light from one or more light sources positioned along at least one edge region and to distribute the light laterally beneath the translucent stone layer. The light-guiding layer may comprise a rigid or flexible light-guide plate or an equivalent optical distribution element depending on the application. The light-guiding layer may further include internal optical features, surface treatments, diffusion features, extraction features, printed patterns, texturing, microstructures, or equivalent light-distribution architecture configured to promote substantially uniform illumination across the translucent stone layer. The particular internal optical architecture of the light-guiding layer may be selected according to desired illumination uniformity, brightness distribution, stone translucency, thickness, and installation conditions, and does not by itself constitute the core inventive aspect of the disclosed system.

A backing structure is disposed on a side of the light-guiding layer opposite the translucent stone layer. The backing structure provides mechanical support for the lighting system and may further serve as a reflective or light-blocking surface to enhance illumination efficiency and uniformity.

The backing structure may be formed from metallic sheets or plates, wood-based panels, polymeric sheets, composite materials, or other suitable substrates, and may be selected based on installation requirements.

At least one elongate light source is arranged along an edge region of the light-guiding layer and is optically coupled thereto such that light emitted by the light source enters the light-guiding layer through the edge. The light source may extend along part or all of an edge of the light-guiding layer and may be positioned along one or multiple edges depending on the desired illumination pattern.

An elongate interface retention structure is provided along an edge region of the light-guiding layer and/or the backing structure to position, support, carry, or retain the elongate light source in operative optical alignment with the exposed edge region of the light-guiding layer. In preferred completion embodiments, the interface arrangement comprises an adhesive interface arrangement selected, sized, or trimmed according to fabricated edge dimensions after edge-related fabrication of the stone-panel laminate, the adhesive interface arrangement carrying and positioning the elongate light source in optical coupling with the exposed edge region of the light-guiding layer. In other embodiments, the elongate interface retention structure may comprise a press-fit channel, clip, carrier, rail, trim, or other retention structure extending along at least a portion of the edge region and configured to receive, carry, or retain the elongate light source from an edge of the system. In many embodiments, particularly where the system is supplied as a stone-panel laminate or thin illuminated panel construction, or where thin stone veneers, masking requirements, assembly tolerances, edge-support requirements, or edge-finishing requirements apply, the elongate interface retention structure may additionally overlap, abut, engage, support, cover, or adhesively contact an edge region or surface portion of the translucent stone layer while remaining functionally associated with the lighting panel. Such overlap, engagement, or adhesive contact does not alter the fact that operative optical alignment and retention of the elongate light source are provided by the interface retention structure and the panel stack rather than by the translucent stone layer.

In certain embodiments, the lighting system further includes an access arrangement (170) that permits installation, servicing, replacement, or adjustment of the light source without removal or damage to the translucent stone layer. The access arrangement maintains access to the light source after the translucent stone layer has been integrated into an installation and may be configured to allow access from an edge, underside, rear side, or concealed region of the illuminated stone assembly.

In other embodiments, retention and optional replacement of the elongate light source may be achieved through the interface arrangement (160) alone, including adhesive-supported, clip-based, carrier-based, or press-fit retention arrangements, without requiring a separate physical access arrangement (170), the elongate light source being retained without requiring the translucent stone layer to define the operative recess, groove, cavity, or channel for receiving and retaining the elongate light source. In preferred completion embodiments, such retention is provided by an adhesive interface arrangement selected, sized, or trimmed after edge-related fabrication of the stone-panel laminate.

In certain embodiments, an edge-accessible receiving region may be defined by an adhesive-supported interface-defined retention region, channel, carrier, rail, trim, clip-defined region, or equivalent structure arranged to permit edge-based insertion, retention, and removal of the elongate light source while maintaining optical coupling to the exposed edge region of the light-guiding layer. In other embodiments, the elongate light source may be carried by an adhesive element, tape, carrier, or other interface arrangement before being butted or otherwise brought into operative optical coupling with the exposed edge region of the light-guiding layer.

The lighting system is configured as a modular assembly that may be cut, trimmed, or sized using standard stone or panel fabrication tools. The modular nature of the system permits handling at different stages of assembly, thereby supporting both off-site and on-site implementation. In preferred embodiments, the stone-panel laminate, including the translucent stone layer, the light-guiding layer, the backing structure, and one or more optical interface layers, is provided as a fabrication-ready intermediate article and is fabricated to final size as a whole before installation of the elongate light source. In further preferred commercial embodiments, the lighting panel is supplied as a modular subassembly for downstream coupling to a selected translucent or semi-translucent stone layer after job-specific fabrication operations have been completed. In other preferred commercial embodiments, the system is supplied as a fabrication-ready intermediate article in the form of a stone-panel laminate for later completion as an illuminated stone assembly after sizing, fabrication, installation, or final edge-component integration, the elongate light source being positioned in optical coupling with an exposed edge region of the light-guiding layer by the interface arrangement. In preferred embodiments, the modular architecture is a fabrication-friendly, later-completed architecture in which the stone-panel laminate is sized, trimmed, cut, shaped, templated, routed, mitered, edge-finished, or otherwise fabricated before installation of the elongate light source, such that later completion is achieved after at least one fabrication operation.

The inventive concept disclosed herein is directed toward a modular lighting integration architecture configured to illuminate translucent or partially translucent surface materials. The selection of materials used to form the light-guiding layer, reflective backing structure, or structural support layers does not form part of the core inventive step and may be varied depending on manufacturing, cost, sustainability, durability, optical performance, or installation requirements. In various embodiments, the fabrication-compatible light-guiding layer may comprise optical polymer materials, glass-based optical substrates, composite optical materials, or recycled optical polymers including but not limited to recycled polystyrene.

Similarly, the fabrication-compatible reflective backing structure may comprise reflective polymer sheets, composite boards, wood-polymer composite substrates, waterproof structural boards, metallic reflective panels, or equivalent reflective structures. In certain embodiments, the interface arrangement may engage one or more layers of the lighting panel or illuminated stone assembly, including the light-guiding layer, backing structure, or edge portions of the translucent stone layer, without departing from the modular lighting integration architecture. In certain embodiments illustrated in FIG. 6, the interface arrangement (160) may comprise a thermally conductive or heat-dissipating retention layer, including but not limited to adhesive tapes or equivalent materials that both retain the elongate light source (150) and facilitate heat transfer. The embodiment may further include a spacing region, clearance gap, or open access region adjacent to the interface arrangement or illuminated stone assembly to permit heat dissipation and to permit access, removal, or maintenance of the elongate light source without obstruction by surrounding structural elements. A reinforcement structure (200), including a light-transmitting honeycomb or equivalent diffusive structure, may extend across or beneath portions of such region, including beneath mitered or edge portions of the stone, while maintaining uniform light distribution across the translucent stone layer (110) and adjacent edge regions. In certain embodiments, installation of the elongate light source is intentionally deferred until after completion of stone fabrication processes to maintain fabrication flexibility. The lighting system is configured to operate with multiple material selections for the light-guiding and backing structures and may further allow interchangeable backing and optical layer materials based on application-specific installation conditions. Any spacing region, clearance gap, surrounding-installation recess, or localized edge accommodation is optional and does not alter the fact that, in preferred embodiments, the translucent stone layer does not define the operative recess, groove, cavity, or channel configured to receive and retain the elongate light source.

### 2. Material-Specific Embodiments

The following embodiments describe non-limiting examples of how the modular edge-lit lighting system may be integrated with different translucent stone constructions. In all embodiments, the lighting system operates in accordance with the general system architecture described above, and variations in stone construction do not alter the fundamental lighting integration principles.

### Embodiment Group A—Thin Translucent Stone & Veneer Panels

In certain embodiments, the translucent or semi-translucent stone layer comprises a thin translucent stone veneer, such as a slate veneer, alabaster sheet or rock sheet material. The stone veneer may be bonded directly to the light-guiding layer or to an intermediate joining layer using adhesive tape, resin, silicone, epoxy, mechanical fasteners, or combinations thereof.

The joining method may be selected based on installation requirements, stone characteristics, or desired reversibility.

A backing structure may be positioned behind the light-guiding layer and may comprise a dark or opaque panel configured to enhance visual contrast and illumination uniformity. In such embodiments, one or more elongate light sources may be secured along an edge region of the light-guiding layer using adhesive mounting, clips, removable carriers, press-fit retention arrangements, or equivalent retention methods. Decorative or masking elements may be provided to conceal the light source or mounting interface when installed.

The lighting system remains modular and serviceable in these embodiments, allowing the stone veneer, light-guiding layer, and backing structure to be fabricated or assembled independently where desired, while permitting access to the light source after installation. In preferred commercial embodiments and in the presently claimed completion method, the relevant layers are combined to form a stone-panel laminate that is fabricated as a whole before later edge-lighting completion.

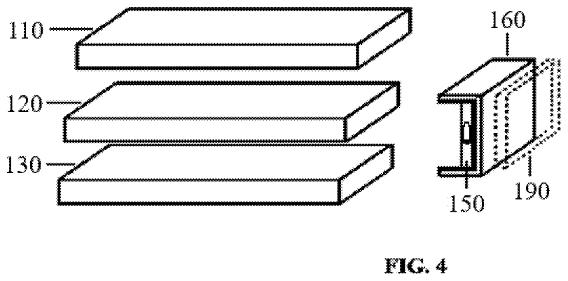

Representative thin-layer configurations are further illustrated in FIG. 4.

### Embodiment Group B—Resin-Bonded Translucent Stone Slabs & Other Cast Stone Panel and Such Systems

In certain embodiments, the translucent stone layer comprises a resin-formed or resin-bonded translucent stone material or similar translucent and semi-translucent resin-bonded materials including but not limited to cast stone materials, gemstone-bonded materials, semi-precious-stone-bonded materials, and other functionally equivalent stone-based materials. Such slabs or panels may include gemstone or semi-precious stone material embedded within a translucent binder, such as a resin or polymer matrix. These constructions may be formed with or without an internal support structure.

In certain embodiments, the resin-bonded translucent stone layer may be formed directly over or bonded onto the light-guiding layer (120), an intermediate optical interface layer (180), or a protective substrate associated with the panel stack or lighting panel. In such embodiments, the resin or binding material may be applied and cured in situ over the lighting panel to form the translucent stone layer as an integrated structure. This approach may be particularly suitable for ultra-thin translucent stone constructions or resin-based composite materials that are not structurally stable for independent fabrication prior to integration with the lighting system.

In some embodiments, the resin-bonded slab or cast panel may be supported by a core structure, such as a light-transmitting honeycomb panel of suitable materials, fibrous reinforcement, or composite substrate, to improve strength, reduce weight, or enhance handling characteristics.

In certain embodiments, one or more stone-forming components may be prepared before completion of the stone-panel laminate. In preferred commercial embodiments, however, the relevant layers are combined to form a stone-panel laminate constituting a fabrication-ready intermediate article for later edge-lighting completion.

In preferred commercial embodiments, the resin-bonded translucent stone layer is combined with the light-guiding layer and backing structure to form a stone-panel laminate that is fabricated as a whole before later addition of the adhesive interface arrangement and elongate light source. In other embodiments, portions of the stone construction may be brought to a desired size or shape before final laminate completion. Due to variations in thickness or material composition, access arrangements and mounting interfaces for the edge-mounted light source may be selected or configured according to job-specific requirements. The lighting system remains accessible and serviceable after installation, regardless of whether the slab or panel includes a core structure. In certain implementations, embodiments of this type may be especially suitable for prefabricated illuminated countertops, islands, tabletops, furniture panels, or kit-manufactured modular illuminated stone panels in which the translucent stone layer is supported over a reinforced core or panel assembly.

For clarity, resin-bonded stone slabs and cast-on stone panels may be known constructions; however, the present invention relates to the modular lighting integration system configured for use with such translucent stone constructions.

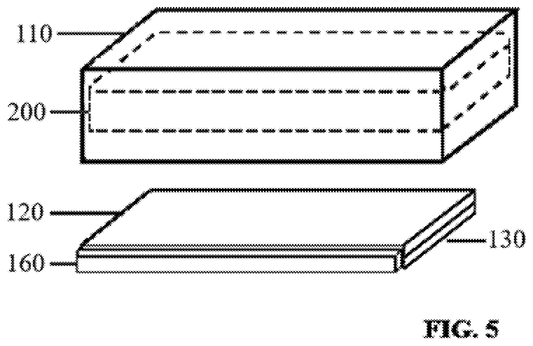

Representative resin-bonded and composite panel configurations, including embodiments with or without an internal core or reinforcement structure (200), are further illustrated in FIGS. 5 and 6.

### Embodiment Group C—Rigid Translucent Stone Slabs

In further embodiments, the translucent stone layer comprises a rigid translucent or semi-translucent slab, including natural stone slabs, engineered stone slabs, or functionally equivalent translucent and semi-translucent stone-based materials. The slab may be fabricated using conventional stone and block cutting and wire-sawing techniques, or by vacuum-compression and related techniques used to bind quartz, glass, polymer resins, pigments, and other binders into rigid slab structures. The slab material may be selected based on its light-transmitting properties. Such slabs may include natural materials such as onyx, marble, or quartzite, as well as engineered stone materials including quartz-based or polymer-bound stone compositions, or composite stone slabs incorporating reinforcement or layered construction, provided that the material permits transmission of light.

Where required, the stone slab may be reinforced or supported using a backing structure, including a composite panel, honeycomb core, or fiber-reinforced substrate, prior to, during, or after formation of a stone-panel laminate, depending on fabrication workflow and installation requirements. In preferred implementations, the rigid translucent stone slab is combined with the light-guiding layer and backing structure to form a stone-panel laminate that may be fabricated as a whole before later addition or adjustment of the edge-mounted light source.

The lighting integration system functions independently of slab thickness and may be adapted to different stone dimensions and reinforcement strategies while preserving access to the light source after installation.

In contrast to resin-formed embodiments described in Embodiment Group B, the translucent stone material in this group is typically provided as a pre-existing rigid slab material or rigid stone construction, which may thereafter be incorporated into a stone-panel laminate and fabricated, sized, or finished in accordance with the modular lighting integration workflow described herein.

Representative natural stone and layered slab configurations are further illustrated in FIGS. 5 and 6.

### 3. Access and Mounting Arrangements

The modular edge-lit lighting system may include one or more optional access arrangements configured to permit installation, servicing, replacement, or adjustment of the edge-mounted light source after the translucent stone layer has been integrated into an installation. The access arrangements described in this section are provided as non-limiting examples and may be selected or modified based on material type, panel thickness, installation constraints, or aesthetic requirements.

In certain embodiments, the access arrangement is defined by or incorporated into the interface arrangement, such that a single structural feature both retains the light source and provides edge-based service access thereto.

In preferred completion embodiments, the access arrangement is provided by or coordinated with an adhesive interface arrangement that both positions the elongate light source in operative optical coupling with the exposed edge region of the light-guiding layer and preserves edge-based service access after fabrication of the stone-panel laminate as a whole.

In preferred embodiments, the access arrangement and/or interface arrangement comprises an adhesive-supported interface-defined retention region in which the elongate light source is carried by an adhesive interface arrangement and retained in operative alignment with the exposed edge region of the light-guiding layer while permitting later insertion, removal, replacement, or adjustment from an edge of the system. Such adhesive-supported retention is selected, sized, or trimmed according to fabricated edge dimensions in those preferred completion embodiments.

In other embodiments, the access arrangement and/or interface arrangement includes an elongate channel, extrusion, LED guide rail, light-source guide rail, carrier, press-fit retention arrangement, or equivalent structure extending along at least a portion of an edge of the light-guiding layer. Such structure may define an edge-accessible receiving region for the light source and may retain the light source in operative alignment with the light-guiding layer while also permitting insertion, removal, or replacement of the light source from an edge of the system. The channel, carrier, or other retention structure may be rigid or flexible and may be removably coupled to the panel stack to preserve serviceability without disturbing the translucent stone layer.

In illuminated stone panel embodiments, the presence of the translucent stone layer does not alter the fact that the elongate light source is positioned in optical coupling with the exposed edge region of the light-guiding layer, and that the translucent stone layer does not define the operative recess, groove, cavity, or channel that receives and retains the elongate light source, even where the interface arrangement overlaps, contacts, or adhesively engages a portion of the translucent stone layer in a supplemental manner.

The lighting integration system may be implemented in a variety of configurations including horizontal structural applications such as countertops, furniture elements, and prefabricated surface assemblies, as well as vertical applications including wall panels, cladding systems, and architectural facades.

Decorative or masking elements may be used in combination with the access arrangement to visually integrate the lighting system with surrounding architectural features. Such elements may include frames, trims, edge bands, or surface finishes selected to match the stone or installation environment.

The access and mounting arrangements described herein are interchangeable and, unless expressly claimed, are not essential to the core lighting integration system. Variations in access or mounting configuration do not alter the fundamental operation of the lighting system as defined in the claims.

In certain embodiments, fabrication of the translucent stone layer may include lamination, miter-edge construction, reinforcement bonding operations, or localized edge-shaping operations that provide spacing, clearance, or an inward-set edge accommodation adjacent to an edge region of the stone layer without requiring the receiving region for the elongate light source to be defined by a recess, groove, cavity, or channel formed in the translucent stone layer. Portions of the lighting panel, including the light-guiding layer, interface arrangement, or edge-mounted light source, may be aligned with, terminate adjacent to, extend beneath, or otherwise cooperate with such edge accommodations. Formation of such spacing or edge-accommodation features during stone fabrication processes does not alter the modular or serviceable nature of the lighting system. In preferred embodiments, the translucent stone layer is not required to be machined with a dedicated longitudinal recess, groove, cavity, or channel for receiving and retaining the elongate light source, although optional edge accommodations, recesses, miter clearances, or finishing structures may be present.

This embodiment is especially suitable for panel constructions that include a reinforced core, but is not limited thereto. The presence of such a core or reinforced diffusive structure adjacent to the edge region allows light to be transmitted toward laminated or mitered edge regions of the stone. This creates even illumination across the stone edge profiles while masking reinforced layer edges. The lighting system may also be installed without such spacing or edge-accommodation features, and the presence or absence of such features does not limit the scope of the invention.

In certain embodiments, the interface arrangement (160) may comprise thermally conductive or heat-absorbing tape-based retention structures configured to permit removal of the elongate light source even in enclosed or mitered or equivalent laminated edge configurations.

Representative access and mounting arrangements are further illustrated in FIG. 7, including edge-mounted retention structures (160) and optional corner or edge finishing arrangements. FIG. 6 is representative of a thermally conductive interface arrangement (160) used with a diffusive reinforced layer (200), shown in this figure as a clear honeycomb sandwich layer masked by a miter edge profile extending through the stone layer (110), with spacing or clearance adjacent to the interface arrangement configured to allow heat dissipation and, in certain embodiments, access to the elongate light source (150), shown here as an LED strip lighting arrangement. FIG. 7 further illustrates representative optional interface and access variations, including corner connection elements and optional inward-set edge geometries, without requiring the receiving region for the elongate light source to be defined by a recess, groove, cavity, or channel formed in the stone layer.

### 4. Installation and Fabrication Methods

The modular edge-lit lighting system described herein supports flexible fabrication and installation workflows commonly used by stone fabricators and installers. The system may be assembled in stages and does not require permanent integration of lighting components prior to fabrication of the translucent stone layer.

In certain workflows, a translucent stone layer—whether a thin stone veneer, a resin-bonded translucent stone slab or composite panel, or a natural translucent stone slab—may first be fabricated, cut, or templated to a desired final size using standard stone fabrication tools. The fabrication process may include trimming, edge profiling, or shaping operations performed prior to laminate formation or prior to final completion of the lighting system. In preferred commercial embodiments and in the presently claimed method, however, the stone-panel laminate is provided as the fabrication-ready intermediate article and is edge-fabricated as a whole using standard stone fabrication tools. In various embodiments, such fabrication operations may be performed using standard stone, panel, or job-site fabrication equipment, including saws, routers, waterjet systems, CNC equipment, grinders, oscillating tools, or hand tools, depending on the material, panel configuration, and installation requirements.

In preferred workflows, the stone-panel laminate is provided as a fabrication-ready intermediate article and undergoes at least one edge-related fabrication operation as a whole before later lighting completion. In certain embodiments, installation of the elongate light source is intentionally deferred until after final sizing, trimming, shaping, templating, routing, or other fabrication of the translucent stone structure and/or associated stone-panel laminate. In a preferred workflow, the stone-panel laminate is provided as a fabrication-ready intermediate article, and at least one edge-related fabrication operation is performed on the stone-panel laminate as a whole while maintaining the exposed edge region free of both the elongate light source and the adhesive interface arrangement. Thereafter, the adhesive interface arrangement is selected, sized, or trimmed according to fabricated edge dimensions before the elongate light source is attached thereto and positioned in optical coupling with the exposed edge region. Where applicable, the elongate light source may be selected and cut to length according to the fabricated edge dimensions before attachment to the adhesive interface arrangement. In broader embodiments, the elongate light source may thereafter be brought into operative optical coupling with the exposed edge region of the light-guiding layer, including by an interface arrangement that positions, supports, carries, or retains the elongate light source at the exposed edge region, thereby allowing the lighting system to accommodate variations in panel dimensions, edge geometry, and installation conditions while preserving later edge-based serviceability.

In many implementations, the stone-panel laminate is fabricated as a whole by a stone fabricator using standard fabrication tools and shop practices applicable to stone work, rather than requiring a separate lighting manufacturer to pre-complete the illuminated panel before stone-fabrication operations are performed. Representative tools may include one or more bridge saws, rail saws, routers, CNC stone-working machines, polishing equipment, grinders, waterjet equipment, panel saws, drilling tools, oscillating tools, and hand tools selected according to the laminate construction and job requirements. Representative cutting tools may include carbide-tipped tools, diamond-based tools, and other fabrication-compatible tools selected according to the stone layer, light-guiding layer, backing structure, and any reinforcement structure. During one or more edge-related fabrication operations, the exposed edge region is maintained free of the adhesive interface arrangement and the elongate light source so that the laminate remains compatible with customary stone-fabrication handling, fixturing, trimming, and edge-finishing procedures. Maintaining the exposed edge region free of the adhesive interface arrangement and the elongate light source preserves access to the exposed edge region during customary stone-fabrication operations and reduces interference with cutting, fixturing, edge-finishing, and handling of the stone-panel laminate as a whole.

In certain embodiments, the lighting integration system is supplied as a kit or modular assembly in which the panel stack, interface arrangement, and light source are provided as separate or partially assembled components for later integration by a fabricator or installer. In preferred commercial embodiments, the kit comprises a modular lighting panel for downstream coupling to a selected translucent stone layer after final cutting, trimming, templating, shaping, or edge processing of the translucent stone structure. In other embodiments, the system is supplied as a stone-panel laminate in which the translucent stone layer has already been combined with the panel stack and one or more optical interface layers positioned between adjacent layers of the laminate and providing bonding and optical coupling, but without requiring the elongate light source or associated edge-mounted components at the time of supply. Such configurations preserve fabrication flexibility and serviceability while protecting the modular supply and downstream installation architecture of the system. In certain preferred commercial embodiments, the stone-panel laminate is supplied as a fabrication-ready intermediate article that later receives the elongate light source at the exposed edge region of the light-guiding layer after final fabrication, installation, or edge finishing. In the presently claimed method, the fabrication-ready intermediate article is the stone-panel laminate, and completion into the illuminated stone panel occurs only after later addition of the adhesive interface arrangement and the elongate light source.

In certain embodiments, the translucent stone layer (110) may be bonded to one or more components of the lighting system, including the light-guiding layer (120) and/or backing structure (130), prior to final sizing or fabrication operations. In such embodiments, the combined assembly may be cut, trimmed, or fabricated as a unit using job-appropriate fabrication tools.

In other embodiments, one or more components may be prepared separately prior to laminate completion.

Accordingly, limited variations in fabrication and integration sequence may be used depending on installation requirements, without departing from the modular and serviceable architecture described herein.

In certain embodiments, fabrication operations may further include formation of internal cutouts, apertures, or openings within the translucent stone structure and/or associated panel stack, including openings for faucets, sinks, electrical outlets, fixtures, controls, or service penetrations. Such internal fabrication operations may be performed before or after installation of the elongate light source (150) and interface arrangement (160), provided that the fabrication does not interfere with the edge region (140) and associated light-source retention arrangement. In preferred workflows, edge-related fabrication operations are completed while the elongate light source (150) is absent from the exposed edge region (140), while non-edge internal cutouts or penetrations may be formed before or after installation of the elongate light source (150) provided that they do not interfere with the exposed edge region (140) or the associated light-source retention arrangement.

The lighting panel may be coupled to the translucent stone layer before installation at a fabrication facility or during on-site installation at the final location. In some embodiments, a stone-panel laminate may be fabricated, supplied, transported, or installed before later addition of the elongate light source and associated edge-mounted components. In some embodiments, the translucent stone layer may be mounted to certain substrates or supporting structures prior to installation of the lighting panel, after which the light source is introduced and secured along the edge region of the light-guiding layer. In preferred completion embodiments, final lighting completion is performed after final sizing or fabrication of the stone-panel laminate as a whole.

The lighting integration system may be supplied or handled at different stages of assembly, including as a panel stack, stone-panel laminate, lighting panel, or illuminated stone assembly, depending on fabrication stage and installation requirements. In preferred commercial embodiments and in the presently claimed method, the stone-panel laminate constitutes the fabrication-ready intermediate article and is fabricated as a whole before later installation of the elongate light source and adhesive interface arrangement.

In certain implementations, the lighting integration system may be provided as a standard-sized modular lighting panel, stone-panel laminate, or illuminated stone assembly with associated lighting components for integration using standard fabrication workflows. The system enables fabrication, handling, and installation with reduced structural modification requirements, including configurations that avoid the need for permanent recessed cavities or comparable substrate alterations. In preferred implementations, the stone-panel laminate provides a commercially viable article that may later receive the elongate light source after final sizing, fabrication, installation, or edge-component integration, with the elongate light source being positioned in optical coupling with the exposed edge region of the light-guiding layer by an adhesive interface arrangement in preferred completion embodiments and with the translucent stone layer not defining the operative recess, groove, cavity, or channel that receives and retains the elongate light source. The modular architecture facilitates efficient fabrication, installation, and serviceability. It further enables reduced material handling complexity and consistent illumination performance across fabricated stone surfaces.

The installation and fabrication methods are adaptable to different stone constructions, panel thicknesses, and reinforcement strategies. Selection of access arrangements, mounting interfaces, and decorative masking elements may be performed on a job-specific basis without altering the fundamental operation of the lighting system. The described methods enable efficient fabrication, reduce installation constraints, and support long-term serviceability of illuminated translucent stone installations. Fabrication or sizing operational sequences (300) are illustrated schematically in FIG. 3 in association with the translucent stone structure and panel stack.

### 5. Optional Features and Variations

The optional features described in this section are provided for completeness and illustration only and do not form part of the essential lighting integration system as defined in the claims. In certain embodiments, the light-guiding layer may comprise polymeric optical materials, optical sheet, diffuser panel, or equivalent light distributing member including polystyrene, glass, acrylic, polycarbonate, or other equivalent light-transmitting, fabrication-compatible materials. In preferred embodiments, the light-guiding layer comprises recycled polystyrene or recycled optical polymer material. The reflective backing layer may comprise reflective polymer sheets, waterproof boards, wood-polymer composites, metallic reflective panels, honeycomb core aluminum panel, or other fabrication-compatible, rigid lightweight backers and reflective substrates selected according to installation environment or structural requirements, wherein the panel stack or lighting panel is configured to operate with interchangeable backing layer materials based on installation requirements.

The modular edge-lit lighting system may incorporate optional features and variations without departing from the scope of the invention as defined by the claims. These features may be selected according to application requirements, installation environments, or user preferences. Material selection for the translucent stone layer, light-guiding layer, backing structure, and one or more optical interface layers is application-dependent and does not define the point of distinction of the presently claimed completion method.

In certain embodiments, the light source may comprise different types of solid-state lighting elements, including side-emitting LEDs, surface mounted device (SMD) LED strips, chip-on-board (COB) lighting elements, or equivalent flexible or rigid light sources capable of edge illumination. The selection of the light source may depend on desired brightness, color temperature, light distribution characteristics, or energy efficiency.

The lighting system may be configured for curved, contoured, or non-planar installations. In such embodiments, one or more components of the lighting system, including the light-guiding layer, backing structure, or access arrangement, may be flexible or segmented to conform to a desired shape while maintaining optical coupling and serviceability.

In some embodiments, sealing elements may be incorporated to provide resistance to moisture, dust, or environmental exposure. Such sealing elements may include gaskets, coatings, encapsulants, or edge seals and may be selected to achieve a desired ingress protection level without limiting access to the light source. Appropriately rated light sources may be further selected for such applications.

The lighting system may further include a power supply, driver, or control module configured to regulate operation of the light source. Control features may include dimming, color tuning, programmable lighting modes, or remote-control interfaces. These control features may be integrated within the lighting panel or illuminated stone assembly, or provided as external components. In certain embodiments, the elongate light source (150) and/or associated power components may be configured for plug-in electrical connection to a socket outlet, thereby allowing the illuminated stone panel to be installed as a plug-and-play assembly in applications where hardwired electrical connection is not required or is not preferred. In other embodiments, the system may be configured for hardwired installation, including installations using drivers, routed wiring paths, concealed electrical connections, or code-dependent fixed electrical connection arrangements. Selection between plug-connected and hardwired configurations may be made according to job conditions, code requirements, and user preference.

Thermal management features may optionally be included to dissipate heat generated by the light source (150). In such embodiments, thermal management and serviceability may be achieved through the use of a heat-dissipating interface arrangement, including heat-absorbing or thermally conductive adhesive tapes (160), conductive light source carriers or rails (160), conductive substrates (130), or airflow pathways, provided that access to the light source remains available for serviceability and replacement.

In certain configurations, a clearance gap, open access region, surrounding-installation recess, or localized edge accommodation may be provided adjacent to the lighting panel or illuminated stone assembly to facilitate heat dissipation and access for maintenance. A reinforcement structure (200), including a light-transmitting honeycomb or equivalent structure, may be positioned to span, underlie, or cover such regions, thereby maintaining structural integrity and enabling uniform light diffusion across the illuminated surface.

The optional features described in this section may be implemented individually or in combination and are not essential to the core lighting integration system.

### 6. Industrial Applicability

The modular edge-lit lighting system described herein is industrially applicable to the manufacture, fabrication, installation, and maintenance of illuminated translucent stone surfaces. The system is suitable for use with a variety of translucent stone and semi-translucent constructions and may be employed in architectural, interior design, and construction industries, including applications involving wall panels, backsplashes, countertops, tabletops, furniture elements, decorative features, and similar installations.

In industrial practice, the lighting integration system may be manufactured, supplied, distributed, and installed as a panel stack, modular lighting panel, stone-panel laminate, or illuminated stone assembly with associated lighting components configured for use in standard fabrication workflows. The system is suitable for downstream coupling, job-site adaptation, maintenance, refurbishment, and replacement in commercial and residential installations while reducing structural modification requirements and supporting consistent illuminated-surface performance.

The disclosed method is particularly applicable in supply chains in which stone fabrication and lighting integration are ordinarily separated across different trades or suppliers. By permitting fabrication of the stone-panel laminate as a fabrication-ready intermediate article, and fabrication of that intermediate article as a whole before later addition of the adhesive interface arrangement and elongate light source, the disclosed workflow enables the intermediate article to move through standard stone-fabrication channels while still supporting later electrical or lighting completion.

What is claimed is:

1. A method of completing an illuminated stone panel, comprising:
providing, as a fabrication-ready intermediate article, a stone-panel laminate comprising a translucent stone layer (110), a light-guiding layer (120), a backing structure (130), and one or more optical interface layers (180), the light-guiding layer (120) and the backing structure (130) together defining a panel stack, the one or more optical interface layers (180) being positioned between adjacent layers of the stone-panel laminate and providing bonding and optical coupling between adjacent layers, the light-guiding layer (120) having an exposed edge region (140);
performing, on the stone-panel laminate as a whole, one or more edge-related fabrication operations selected from cutting, trimming, routing, mitering, edge-finishing, and edge profiling using one or more standard stone-fabrication tools while maintaining the exposed edge region (140) free of both an elongate light source (150) and an adhesive interface arrangement (160);
after completing the one or more edge-related fabrication operations, selecting, sizing, or trimming the adhesive interface arrangement (160) according to fabricated edge dimensions of the stone-panel laminate;
attaching the elongate light source (150) to the adhesive interface arrangement (160) after the adhesive interface arrangement (160) has been selected, sized, or trimmed according to the fabricated edge dimensions of the stone-panel laminate;
thereafter positioning the elongate light source (150), by the adhesive interface arrangement (160), in optical coupling with the exposed edge region (140) of the light-guiding layer (120); and
completing the illuminated stone panel,
wherein the stone-panel laminate is handled in a stone-fabrication workflow before addition of the adhesive interface arrangement (160) and the elongate light source (150), and
wherein the translucent stone layer (110) does not define a recess, groove, cavity, or channel that receives and retains the elongate light source (150).

2. The method of claim 1, wherein the one or more edge-related fabrication operations are performed in a stone-fabrication workflow, and later completion with the adhesive interface arrangement (160) and the elongate light source (150) is performed in a separate lighting-completion workflow.

3. The method of claim 1, wherein the fabrication-ready intermediate article is supplied, transported, or transferred between the stone-fabrication workflow and the lighting-completion workflow before the adhesive interface arrangement (160) and the elongate light source (150) are added.

4. The method of claim 1, wherein the stone-panel laminate is edge-profiled, mitered, polished, or cut to job-specific dimensions while the exposed edge region (140) remains free of both the adhesive interface arrangement (160) and the elongate light source (150), such that the adhesive interface arrangement (160) is selected, sized, or trimmed only after completion of the job-specific edge fabrication.
